(19) United States
(12) Patent Application Publication
(10) Pub. No.: US 2023/0177195 A1
(43) Pub. Date: Jun. 8, 2023

(54) COMPLEX ANALYSIS DATA MANAGEMENT SYSTEM, COMPLEX ANALYSIS DATA MANAGEMENT METHOD, AND NON-TRANSITORY COMPUTER READABLE STORAGE MEDIUM

(71) Applicant: SHIMADZU CORPORATION, Kyoto (JP)

(72) Inventors: Tomohiro KAWASE, Kyoto-shi, Kyoto (JP); Shiori NAGAI, Kyoto-shi, Kyoto (JP)

(73) Assignee: SHIMADZU CORPORATION, Kyoto (JP)

(21) Appl. No.: 17/921,969

(22) PCT Filed: Mar. 24, 2021
(86) PCT No.: PCT/JP2021/012138

§ 371 Date: Oct. 27, 2022

(30) Foreign Application Priority Data
Apr. 30, 2020 (JP) 2020-080177

(51) Int. Cl. G06F 21/62; G06F 21/60

(52) U.S. Cl. CPC G06F 21/6218; G06F 21/604; G06F 2221/2117; G06F 2221/2141

(57) ABSTRACT

The complex analysis database manages the analysis result data in association with each of the plurality of samples. A project-sample registering unit registers, in a project database, a respective one of a plurality of projects in association with one or more selected from the plurality of samples. A project-user registering unit registers, in the project database, a respective one of the plurality of projects in association with one or more selected from a plurality of users. The display control unit displays a project associated with the login user in a selectable manner on an information terminal operated by the login user. The display control unit extracts, from a complex analysis database, the analysis result data of a sample associated with the project selected by the login user and displays the extracted data on the information terminal.

### TECHNICAL FIELD

This disclosure relates to a complex analysis data management system, a complex analysis data management method, and a complex analysis data management program.

### BACKGROUND ART

So far have been developed and disclosed analysis systems designed to analyze a plurality of analysis results obtained by different analyzers in a cross-sectional manner (hereinafter, may be referred to as multi-analyzer cross analysis systems). Japanese Patent Laying-Open No. 2017-194360 (patent literature 1) describes an example of such analysis systems. The specimen analysis system described in this literature obtains measured data of a target specimen using a plurality of analyzers and determines the target specimen based on the obtained measured data. The analyzers used then include at least one of a fluorescent X-ray analyzer, an atomic absorption photometer and an inductively coupled plasma-atomic emission spectrometer and also include at least one of an infrared spectrophotometer or a Raman spectrometer. The system described in patent literature 1 pursues to determine the target specimen with a higher accuracy through combined use of different pieces of measured data respectively obtained from a device(s) suitable for analysis of inorganic matter and a device(s) suitable for analysis of organic matter.

### CITATION LIST

### Patent Literature

[Patent Literature 1] Japanese Patent Laying-Open No. 2017-194360

### SUMMARY OF INVENTION

### Technical Problem

In the multi-analyzer cross analysis system described above, different analysis results may be obtainable for one sample by a plurality of analyzers, conducing to multilateral sample analysis. This system may be expected to perform very accurate analyses.

Some of the analysis results, however, may possibly be obtained for specific purposes, for example, product development. Such analysis results may contain confidential data that needs to be carefully handled by parties involved in the development. Accesses by any third parties to these analysis results should necessarily be limited or blocked in order to avoid unauthorized use of these results.

To address these issues of the known art, this disclosure is directed to, in an analysis system for cross-sectional analysis of results obtained by a plurality of analyzers, achieving data management that enables shared use of the analysis results while ensuring, at the same time, confidentiality required of these results.

### Solution to the Problem

A complex analysis data management system according to a first aspect of this disclosure is for management of analysis result data obtained by a plurality of types of analyzers for each of a plurality of samples. The complex analysis data management system includes: a complex analysis database; a user database; a project database; a project-sample registering unit; a project-user registering unit; a login management unit; and a display control unit. The complex analysis database manages the analysis result data in association with each of the plurality of samples. The user database manages a plurality of users who can log in the complex analysis data management system. The project database manages a plurality of projects. The project-sample registering unit registers, in the project database, a respective one of the plurality of projects in association with at least one selected from the plurality of samples. The project-user registering unit registers, in the project database, a respective one of the plurality of projects in association with at least one selected from the plurality of users. The login management unit identifies a login user in response to input of a login operation by one of the plurality of users. The display control unit displays a project associated with the login user in a selectable manner on an information terminal operated by the login user. The display control unit extracts, from the complex analysis database, the analysis result data of a sample associated with the project selected by the login user and displays the extracted analysis result data on the information terminal.

### Advantageous Effects of Invention

The analysis system disclosed herein for cross-sectional analysis of results obtained by a plurality of analyzers may successfully achieve data management that enables shared use of analysis results while ensuring, at the same time, confidentiality required of these results.

### BRIEF DESCRIPTION OF DRAWINGS

FIG. 1 is a schematic drawing that illustrates a complex analysis data management system according to an embodiment of this disclosure.

FIG. 2 is a schematic drawing that illustrates the concept of a project.

FIG. 3 is a block diagram that schematically illustrates hardware elements of an information processor, a server, and an information terminal.

FIG. 4 is a block diagram that schematically illustrates functional elements of the information processor, server, and information terminal.

FIG. 5 is a block diagram that schematically illustrates functional elements of a database.

FIG. 6 is a block diagram that schematically illustrates an exemplified configuration of a complex analysis database.

FIG. 7 is a table that illustrates information of project-user registration.

FIG. 8 is a table that illustrates information of project-sample registration.

FIG. 9 is a block diagram that schematically illustrates details of an authority granted to a user U1.

FIG. 10 is a flow chart of processing steps associated with user authority management in a server.

FIG. 11 is a flow chart of processing steps for display in an information terminal.

FIG. 12 is a drawing that illustrates an exemplified operation screen.

FIG. 13 is a drawing of a template selectable screen.

FIG. 14 is an exemplified table schematically showing attribute values of samples.

FIG. 15 is a drawing that schematically illustrates functional elements of database according to a modified embodiment.

FIG. 16 is a table that illustrates information of template-user registration.

FIG. 17 is a drawing of a template selectable screen.

### DESCRIPTION OF EMBODIMENTS

Embodiments of this disclosure are hereinafter described in detail referring to the accompanying drawings. The same or similar components and units in the drawings are simply illustrated with the same reference signs, redundant description of which will basically be omitted.

### Overall Configuration of Complex Analysis Data Management System

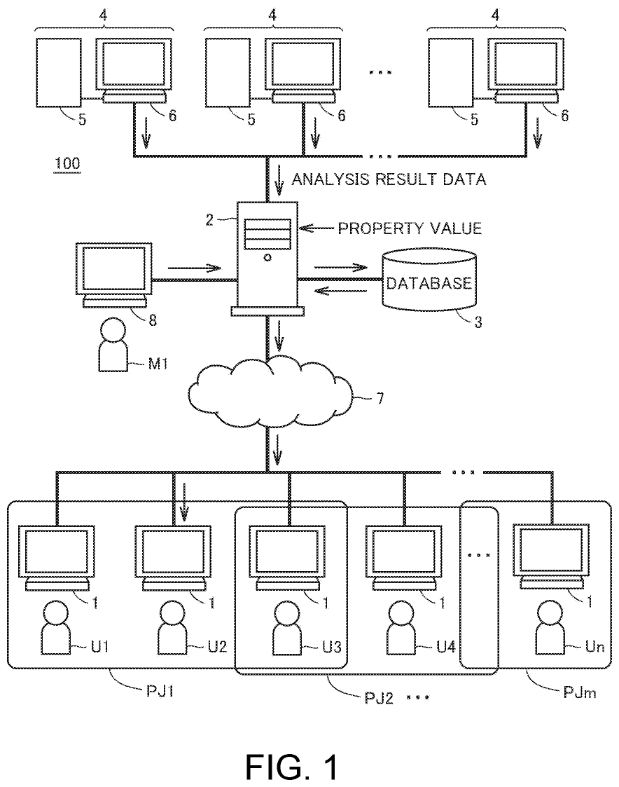

FIG. 1 is a schematic drawing that illustrates a complex analysis data management system according to this embodiment. A complex analysis data management system 100 according to this embodiment is applicable to multi-analyzer cross analysis systems for cross study of analysis results obtained by a plurality of types of analyzers.

Referring to FIG. 1, complex analysis data management system 100 includes a plurality of analyzers 4, a server 2, a database 3, and a plurality of information terminals 1.

The analyzers 4 analyze samples. Examples of analyzers 4 may include the following; liquid chromatography device (LC), gas chromatography device (GC), liquid chromatography mass spectrometer (LC-MS), gas chromatography mass spectrometer (GC-MS), scanning electron microscope (SEM), transmission electron microscope (TEM), energy dispersive fluorescent X-ray analyzer (EDX), wavelength dispersive fluorescent X-ray analyzer (WDX), and Fourier transform infrared spectrophotometer (FT-IR). Other examples of analyzers 4 may include photodiode array detector (LC-PDA), liquid chromatography tandem mass analyzer (LC/MS/MS), gas chromatography tandem mass spectrometer (GC/MS/MS), liquid chromatography tandem mass spectrometer (LC/MS-IT-TOF); near-infrared spectroscopy device, tension tester, and compression tester.

In complex analysis data management system 100 according to this embodiment, different types of analyzers are used as analyzers 4 illustrated in FIG. 1. Thus, one sample may be multilaterally analyzed by analyzers 4 that differ from each other.

Analyzers 4 each include a device body 5 and an information processor 6. Device body 5 analyzes a sample selected as an analysis target. Information processor 6 receives input of pieces of information including an analysis condition and identification information of the sample.

Information processor 6 controls an analysis performed by device body 5 under the input analysis condition. Thus, device body 5 obtains “analysis data”; an analysis result obtained from the sample. Information processor 6 analyzes the analysis data obtained by device body 5 using a piece of software dedicated for data analysis and thereby extracts a “feature amount” of the sample.

Information processor 6 stores, in its built-in memory, the extracted feature amount of the sample along with the analysis condition, identification information and analysis data of the sample. Specifically, information processor 6 collectively stores, for each of the samples, the analysis condition, identification information, analysis data and feature amount in the memory as “analysis result data”.

Information processor 6 and server 2 are interconnected to allow communication therebetween. The connection between information processor 6 and server 2 may be either wireless or wired connection. For instance, the Internet may be used as a communication network that connects information processor 6 to server 2. Thus, information processor 6 of each analyzer 4 may transmit the analysis result data of each sample to server 2.

Server 2 is mostly used for management of the analysis result data obtained by different analyzers 4. Server 2 receives, from each of analyzers 4, input of the analysis result data for each of the samples. Server 2 may further receive input of a “property value” of each sample from a source or an apparatus on the outside of server 2.

The property value of a sample is a value representing the attribute of a sample obtained through any approach but the analysis conducted by each analyzer 4. The feature amount described above corresponds to a sample's attribute value obtained through the analysis by analyzer 4 or attribute value obtainable by executing a computing process to the attribute value obtained through the analysis. The feature amount and the property value of a sample may be used in statistical analysis or machine learning.

While server 2 receives input of a sample's property value in the example illustrated in FIG. 1, analyzer 4 may instead receive the property value input. In this instance, analyzer 4 transmits, to server 2, the property value as well as the analysis result data for each sample. Otherwise, information terminal 1, which will be described later, may receive the input of the sample's property value.

Database 3 is connected to server 2. Database 3 is a storage in which pieces of data are storable, including data transmitted and received to and from server 2 and analyzers 4, and input data received from a source or an apparatus on the outside of server 2. While database 3 is a storage externally mounted to server 2 in the example of FIG. 1, database 3 may be incorporated in server 2. Server 2 obtains the analysis result data and the property value of each sample, this server then stores, for each sample, the analysis result data and property value in database 3 in association with each other.

Server 2 is connected to Internet 7. A plurality of information terminals 1 are connected to Internet 7. This may allow information terminals 1 to transmit and receive data to and from server 2 through Internet 7. Internet 7 is just an example of communication networks that can provide connection between server 2 and information terminals 1.

Information terminal 1 may display the analysis result data and the property value of a sample selected by a user (for example, person who performs analysis) as a target to be displayed. Examples of the information terminal 1 may include communication feature-equipped personal computers and mobile terminals including mobile phones, smartphones and tablets.

Information terminal 1, in response to the input of a sample to be displayed selected by a user, accesses server 2 through Internet 7 to obtain the analysis result data and the property value of the selected sample stored in database 3. Information terminal 1 then displays the obtained analysis result data and property value on its screen. When two or more samples are chosen to be displayed, information terminal 1 may display pieces of analysis result data and property values of these samples on its screen next to one another.

In the example of FIG. 1, each of users U1 to Un (n is a plural number), when selecting a sample to be displayed, is allowed to access the analysis result data of the selected sample obtained by analyzers 4. This may facilitate the cross study of the analysis results obtained by different analyzers 4, leading to a very efficient and accurate analysis.

Further advantageously, users U1 to Un are allowed to share pieces of analysis result data of samples stored in database 3. Thus, any analysis result data available then may be fully effectively used.

Among pieces of analysis result data of different samples are included data intended for certain purposes, for example, product development. Such data should naturally be handled with confidentiality by parties involved in the development. Accesses by any third parties to such confidential analysis result data should necessarily be limited or blocked in order to avoid unauthorized use of such data.

To this end, complex analysis data management system 100 according to this embodiment defines and sets user authorities for accessibility to the samples' analysis result data. In the example illustrated in FIG. 1, a manager M1 of complex analysis data management system 100 may set, for users U1 to Un, an authority to access pieces of analysis result data of a plurality of samples stored in database 3. For instance, manager M1 may set the user authorities using an information processor 8 connected to server 2 allowed to communicate with this processor.

The authorities for user accessibility (i.e., a range of accessible data) may be decided and set depending on the attributes of users and samples. In this embodiment, the concept of a “frame” referred to as “project” is employed as the user and sample attributes. In this specification, the “project” indicates a frame that defines a collective entity of samples and users to be controlled in order to achieve a common object, for example, successful development of a certain product.

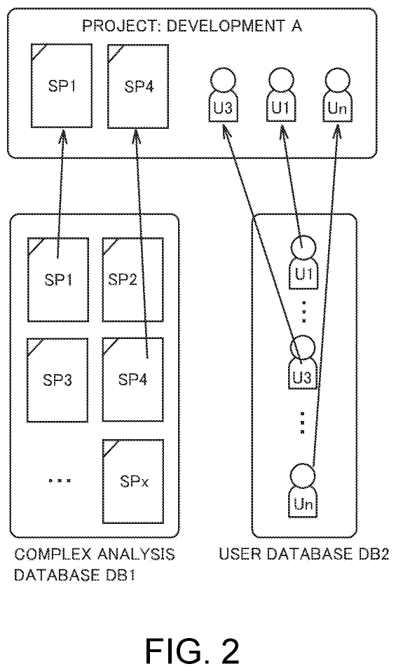

FIG. 2 is a schematic drawing that illustrates the concept of a project. Taking, for instance, a project for development of a certain product A (hereinafter, may be referred to as “development A”), users U1, U3, Un engaged in development A (for example, designer, manufacturer, person who performs analysis) belong to this project, as illustrated in FIG. 2. Further, pieces of analysis result data of samples SP1 and SP4 obtained by analyzers 4 also belong to development A. Users U1, U3, Un are granted the authority to access the pieces of analysis result data of samples SP1 and SP4 that belong to development A.

The sample analysis result data and users belonging to the project may be registered in a database for project management (hereinafter, may be referred to as “project database”). In case, for example, user U1 is no longer engaged in the ongoing development A, user U1 currently registered in development A is deleted from the project database. Thus, the authority that allows user U1 to access the pieces of analysis result data of samples SP1 and SP4 may instantly become invalid.

In case a new user starts to participate in development A, this new user, when registered in development A in the project database, may be automatically authorized to access the pieces of analysis result data of samples SP1 and SP4.

Whenever the analysis result data of a sample is obtained for development A during the ongoing process of development A, the obtained analysis result data is registered in the project database in association with development A. Thus, any user who belongs to development A may be automatically authorized to access the sample analysis result data most recently obtained.

In complex analysis data management system 100 according to this embodiment, the users and the pieces of the analysis result data of samples are registered in the frame called “project”. These registered pieces of information may facilitate management of the user authority to access the sample analysis result data.

In the example illustrated in FIG. 1, users U1 to Un each belong to one of projects PJ1 to PJm (m is a plural number). Users U1 to Un are, therefore, allowed to access pieces of analysis result data of samples registered in their own projects (projects in which they are registered). This may be rephrased that these users are not allowed to access pieces of analysis result data of samples registered in any project but their own projects. Each user may belong to two or more projects.

### Hardware Configuration of Complex Analysis Data Management System

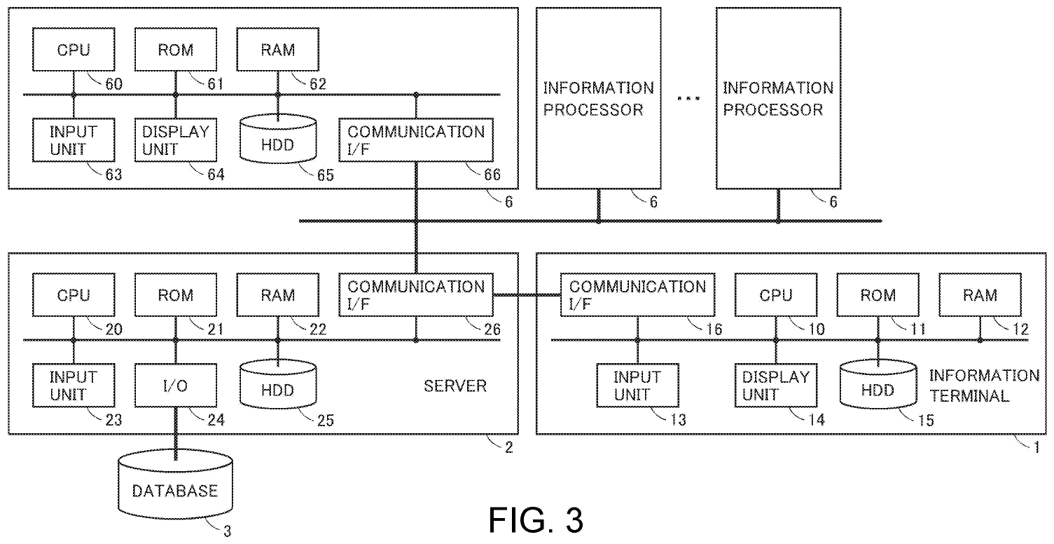

FIG. 3 is a block diagram that schematically illustrates hardware elements of information processor 6, server 2, and information terminal 1.

Referring to FIG. 3, information processor 6 includes a CPU (Central Processing Unit) 60 in charge of control of the whole analyzer 4, and a storage unit in which a program and data are storable. Information processor 6 is configured to operate in accordance with the program.

The storage unit includes a ROM (Read Only Memory) 61, a RAM (Random Access Memory) 62 and an HDD (Hard Disk Drive) 65. ROM 61 is a storage in which a program to be executed by CPU 60 is storable. RAM 62 is a storage in which data used during the program execution by CPU 60 is temporarily storable. RAM 62 may be a temporary data memory, serving as a working region. HDD 65 is a non-volatile storage. In HDD 65 are storable measured data obtained by device body 5, and pieces of information generated by information processor 6 including analysis results obtained by information processor 6. A semiconductor storage device, like a flash memory, may be used in addition to or in place of HDD 65.

Information processor 6 further includes a communication interface (I/F) 66, an input unit 63 and a display unit 64. Communication I/F 66 is an interface provided for information processor 6 to communicate with external devices including device body 5 and server 2.

Input unit 63 receives information input including instructions for information processor 6 received from a user (for example, person who performs analysis). Input unit 63 includes a keyboard, a mouse, and a touch panel integral with the display screen of display unit 64. This input unit receives the input of an analysis condition and identification information of a sample.

For setting of the analysis condition, display unit 64 may display, for example, an input screen for analysis condition and the sample's identification information. During the analysis, display unit 64 may display measured data obtained by device body 5 and an analysis result obtained by information processor 6.

Processes to be executed by analyzer 4 are implementable by hardware elements and software run by CPU 60. The software may be prestored in ROM 61 or HDD 65. Otherwise, the software may be stored in a recording medium not illustrated in the drawings and commercially available as a program product. CPU 60 reads the software from HDD 65, and the read software is stored in RAM 62 in a format executable by CPU 60. Then, CPU 60 executes this software program.

### Hardware Configuration of Server

Server 2 includes a CPU (Central Processing Unit) 20 in charge of control of the whole device and a storage unit in which a program and data are storable. Server 2 is configured to operate in accordance with the program. The storage unit includes a ROM 21, a RAM 22 and an HDD 25.

ROM 21 is a storage in which a program to be executed by CPU 20 is storable. RAM 22 is a storage in which data used during the program execution by CPU 20 is temporarily storable. RAM 22 may be a temporary data memory, serving as a working region. HDD 25 is a non-volatile storage in which pieces of information transmitted from information processor 6 are storable.

Server 2 further includes a communication I/F 26, an input-output interface (I/O) 24 and an input unit 23. Communication I/F 26 is an interface provided for server 2 to communicate with external devices including information processors 6 and 8 and information terminal 1.

I/O 24 is an interface used for input to or output from server 2. I/O 24 is connected to database 3. Database 3 is a memory in which data transmitted and received to and from server 2 and information processors 6 and 8 are storable.

Input unit 23 includes a keyboard and a mouse and receives information input including instructions from a user (for example, manager MD. Input unit 23 receives, for example, pieces of information relevant to sample property values.

### Hardware Configuration of Information Terminal

Information terminal 1 includes a CPU 10 in charge of control of the whole device and a storage unit in which a program and data are storable. Information terminal 1 is configured to operate in accordance with the program. The storage unit includes a ROM 11, a RAM 12 and an HDD 15.

ROM 11 is a storage in which a program to be executed by CPU 10 is storable. RAM 12 is a storage in which data used during the program execution by CPU 10 is temporarily storable. RAM 12 may be a temporary data memory usable as a working region. HDD 15 is a non-volatile storage in which pieces of information transmitted from server 2 are storable.

Information terminal 1 further includes a communication interface (I/F) 16, an input unit 13 and a display unit 14. Communication I/F 16 is an interface provided for information terminal 1 to communicate with external devices including server 2.

Input unit 13 receives information input including a user's (for example, analyzer's) instructions for information terminal 1. Input unit 13 includes a keyboard, a mouse, and a touch panel integral with the display screen of display unit 14. This input unit receives the input of a selected target to be displayed.

When a target to be displayed is selected, display unit 14 may display, for example, an operation screen on which the target is selectable. Display unit 14 may further display the analysis result data of a sample selected as the target to be displayed.

Processes to be executed by information terminal 1 are implementable by hardware elements and the software run by CPU 10. The software may be prestored in ROM 11 or HDD 15. Otherwise, the software may be stored in a recording medium not illustrated in the drawings and commercially available as a program product. CPU 10 reads the software from HDD 15, and the read software is stored in RAM 12 in a format executable by CPU 10. Then, CPU 10 executes the program of this software.

### Functional Configuration of Complex Analysis Data Management System

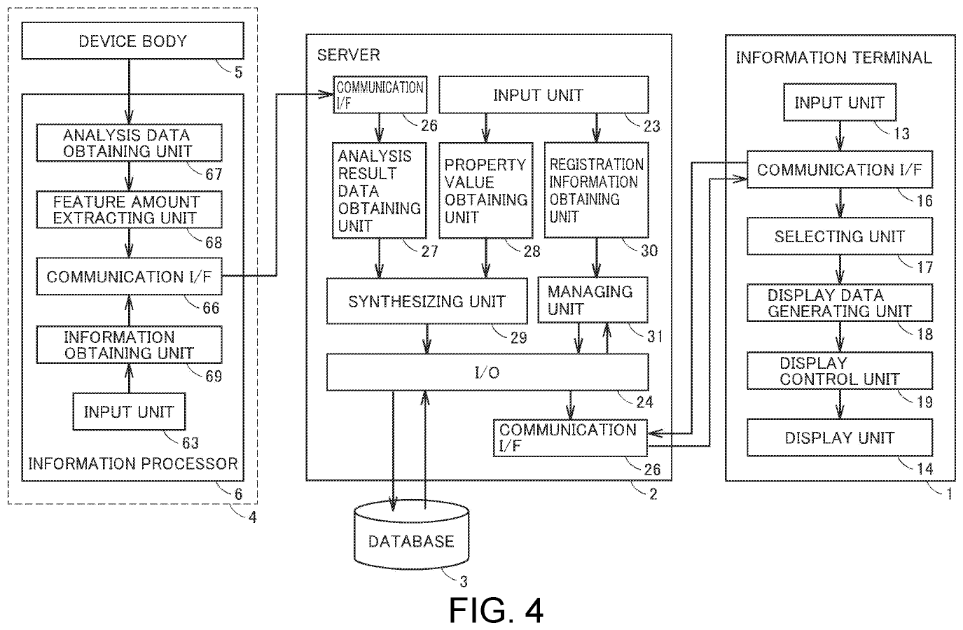

FIG. 4 is a block diagram that schematically illustrates functional elements of information processor 6, server 2, and information terminal 1.

### Functional Configuration of Information Processor

Referring to FIG. 4, information processor 6 includes an analysis data obtaining unit 67, a feature amount extracting unit 68 and an information obtaining unit 69. These functional elements are implementable by having a predetermined program run by CPU 60 in information processor 6 illustrated in FIG. 3.

Analysis data obtaining unit 67 obtains analysis data; an analysis result obtained from the sample, from device body 5. In case analyzer 4 is, for example, a chromatograph mass spectrometer, the analysis data includes a chromatogram and a mass spectrum. In case analyzer 4 is, for example, a scanning electron microscope or a transmission electron microscope, the analysis data includes image data containing a microscopic image(s) of a sample. Analysis data obtaining unit 67 transfers the obtained analysis data to feature amount extracting unit 68.

Feature amount extracting unit 68 analyzes the analysis data transferred from analysis data obtaining unit 67 using a dedicated data analyzing software and thereby extracts the feature amount of a sample. The sample's feature amount may include, for example, a component(s) included in the sample, particle sizes of the component, peak intensity and peak area of a spectrum, absorbance, reflectivity, test strength, Young's modulus, tension strength, deformation amount, distortion amount, and rupture time. In case the analysis data is, for example, a chromatogram, the feature amount includes the peak intensity and peak area.

Information obtaining unit 69 obtains the information input received by input unit 63. Specifically, information obtaining unit 69 obtains pieces of information including of the identification information and analysis condition of a sample. The sample identification information may contain, for example, the name of a sample, and the name, model number and serial number of a material(s) from which the sample has been collected. The sample analysis condition contains device parameters including the name and the model number of an analyzer to be used and measurement parameters indicative of conditions for measurement, for example, temperature condition or voltage- and/or current-applying condition(s).

Communication I/F 66 combines the obtained analysis data, analysis condition, sample identification information and extracted feature amount into a block of data for each sample, and then transmits this combined data to server 2 as the analysis result data.

### Functional Configuration of Server

Server 2 includes an analysis result data obtaining unit 27, a property value obtaining unit 28, a synthesizing unit 29, a registration information obtaining unit 30, and a managing unit 31. These functional elements are implementable by having a predetermined program run by CPU 20 in server 2 illustrated in FIG. 3.

Analysis result data obtaining unit 27 obtains, through communication I/F 26, the analysis result data transmitted from information processor 6 of each analyzer 4. As described earlier, the analysis result data is a block of data containing the analysis condition, sample identification information and analysis data obtained by analyzer 4 and the feature amount extracted from the analysis data.

Property value obtaining unit 28 obtains information containing the property value of a sample received by input unit 63. The property value of a sample is a value representing the attribute of a sample obtained through any approach but the analysis conducted by each analyzer 4. The property value includes, for example, a value representing a level of performance or a degree of degradation of the sample (length of use).

Synthesizing unit 29 associates the analysis result data (sample identification information, analysis condition, analysis data and feature amount) with the property value for each sample. Synthesizing unit 29 stores these pieces of data associated with one another for each sample in database 3 through I/O 24. In case two or more pieces of analysis result data obtained by different analyzers 4 are available for one sample, server 2 collectively handles these pieces of analysis result data and then stores them in database 3 in association with the property value of the sample. Thus, pieces of analysis result data are piled up for each sample and stored in database 3.

Registration information obtaining unit 30 obtains the project-related information received by communication I/F 26. The project-related information is registered by manager M1 of complex analysis data management system 100. The project-related information contains “project-user information” and “project-sample information”. The project-user information” is for management of a project in association with a user who belongs to the project. The “project-sample information” is for management of a project in association with a sample whose analysis result data is accessible by an authorized user who belongs to the project.

Managing unit 31 stores the project-related information obtained by registration information obtaining unit 30 in database 3 through I/O 24. Further, managing unit 31 manages accesses to the analysis result data by a login user based on the project-related information stored in database 3. Specifically, when one of users U1 to Un logs in complex analysis data management system 100, managing unit 31 identifies the user who logged in the system, and then manages a range of data accessible by the login user based on the project-user information and the project-sample information. Managing unit 31 is an element that actualizes the “project-sample registering unit”, “project-user registering unit” and “login management unit” as claimed.

### Functional Configuration of Information Terminal

Information terminal 1 includes a selecting unit 17, a display data generating unit 18 and a display control unit 19. These functional elements are implementable by having a predetermined program run by CPU 10 in information terminal 1 illustrated in FIG. 3.

Selecting unit 17 selects a target to be displayed on information terminal 1 in response to input of a user's selection received by input unit 13. This selection of the target to be displayed includes the selection of a project, the selection of a sample, and the selection of attribute values of the sample (feature amount and property value). As described later, display unit 14 of information terminal 1 displays an operation screen that allows a user to login complex analysis data management system 100 and to select a target to be displayed. The user is allowed to log in the system and select any desired option using input unit 13 on the operation screen.

Specifically, selecting unit 17 selects one of projects PJ1 to PJm in response to the input of a user's selection. Selecting unit 17 further selects a sample to be displayed from at least one or more samples managed in the selected project in response to the input of a user's selection. Selecting unit 17 further selects the attribute values (feature amount and property value) to be displayed of the selected sample in response to the input of a user's selection.

Display data generating unit 18 accesses server 2 through Internet 7 to obtain, from database 3, the analysis result data of the sample chosen to be displayed. As described earlier, the analysis result data contains pieces of sample analysis data obtained by analyzers 4 and analysis conditions relevant to these pieces of data, sample identification information, and feature amount extracted from the analysis data. For each of the samples, its property value is associated with the analysis result data.

Display data generating unit 18 extracts the analysis data and the attribute values selected by selecting unit 17 from the analysis result data obtained from database 3 to generate data to be displayed in a format displayable on the screen.

Display control unit 19 displays the data generated by display data generating unit 18 on display unit 14. When input unit 13 receives the input of a user's instructions for the display format, display control unit 19 may change the format as requested by the user. Display data generating unit 18 and display control unit 19 are elements according to an embodiment of the “display control unit” as claimed.

### Functional Configuration of Database

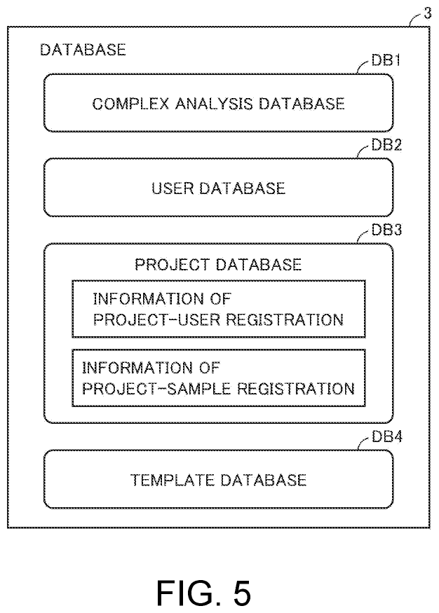

FIG. 5 is a block diagram that schematically illustrates functional elements of database 3.

Referring to FIG. 5, database 3 includes a complex analysis database DB1, a user database DB2, a project database DB3 and a template database DB4.

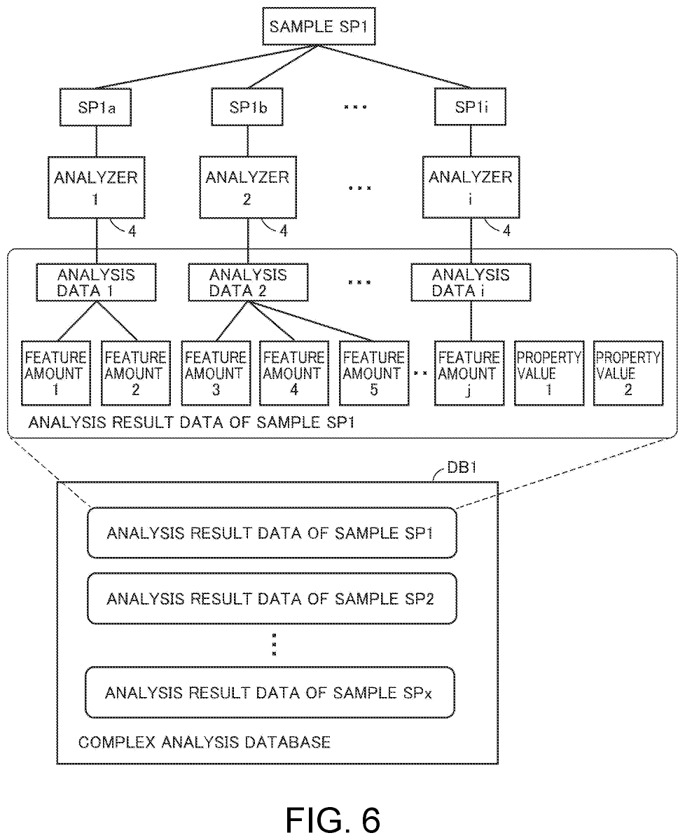

Complex analysis database DB1 is used for management of pieces of analysis result data obtained by different analyzers 4 (see FIG. 1) for each one of samples. FIG. 6 is a block diagram that schematically illustrates an exemplified configuration of complex analysis database DB1. As illustrated in FIG. 6, pieces of analysis result data of samples obtained by different analyzers 4 (see FIG. 1) are stored in complex analysis database DB1.

The pieces of analysis result data of the samples are collectively handled for each sample. FIG. 6 illustrates details of the analysis result data of sample SP1 among samples SP1 to SPx (x is a plural number). The analysis result data of sample SP1 contains a plurality of pieces of analysis data obtained by different analyzers 4.

For the analysis of sample SP1, specimens SP1a to SP1i are each prepared from sample SP1 in a condition suitable for analysis by a respective one of analyzers; a first analyzer 4 to an (i)^{th} analyzer 4 (i is a plural number). In case sample SP1 is in solid form, specimens SP1a to SP1i may each include, other than a portion directly collected from sample SP1, a portion of sample SP in the form of an aqueous solution or a portion of sample SP in the form of a gas.

Specimens SP1a to SP1i are respectively analyzed by first to (i)^{th} analyzers 4. In case first analyzer 4 is, for example, a chromatograph mass spectrometer, a first analysis data obtained by first analyzer 4 includes a chromatogram and a mass spectrum. In case second analyzer 4 is, for example, a scanning electron microscope or a transmission electron microscope, a second analysis data obtained by second analyzer 4 includes image data containing a microscopic image(s) of a sample.

The first analysis data obtained by first analyzer 4, the second analysis data obtained by second analyzer 4 and an (i)^{th} analysis data obtained by (i)^{th} analyzer 4 are combined into a block of analysis result data of sample SP1.

The analysis result data of sample SP1 contains feature amounts extracted by analyzing the analysis data of sample SP1 using a piece of software dedicated for data analysis. In case the first analysis data is, for example, a chromatogram, a first feature amount and a second feature amount extracted from the first analysis data each contain a peak intensity and a peak area. In case the second analysis data is an SEM image, third to fifth feature amounts extracted from the second analysis data each contain particle size-related information, for example, an average particle size obtained from the SEM image.

The analysis result data of sample SP1 further contains property values of sample SP1. The property value of sample SP1 is a value representing the attribute of sample SP1 obtained through any approach but the analysis conducted by each analyzers 4. A first property value and a second property value may include a value representing a level of performance or a degree of degradation of sample SP1.

Referring to FIG. 5 again, user database DB2 is used for management of users U1 to Un allowed to access (log in) complex analysis data management system 100. In user database DB2 is stored pieces of identification information of users U1 to Un (for example, user ID).

Project database DB3 is used for management of projects PJ1 to PJm. In project database DB3 are stored information of project-user registration and information of project-sample registration.

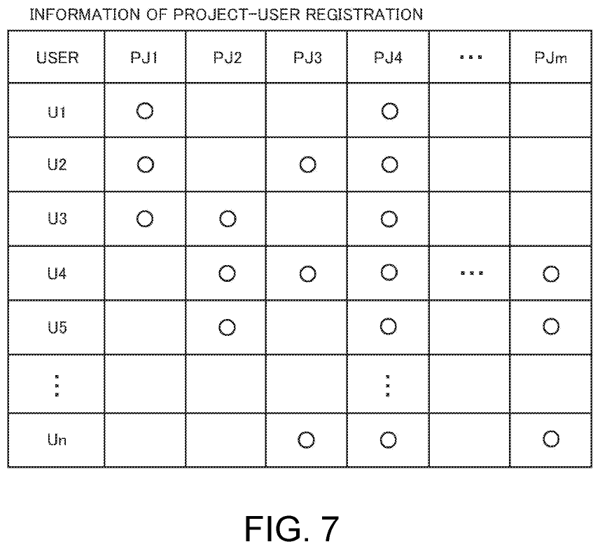

FIG. 7 is a table that illustrates the information of project-user registration. As illustrated in FIG. 7, the information of project-user registration contains, for each of projects PJ1 to PJm, information of at least one user managed in accordance with the project (for example, user identification information). In the example illustrated in FIG. 7, users U1 to U3 are currently registered in project PJ1, users U3 to U5 registered in project PJ2, and all of users U1 to Un registered in project PJ4.

The users may be each registered in two or more projects. In the example of FIG. 7, user U1 is currently registered in projects PJ1 and PJ4. In this instance, user U1, at the time of login to complex analysis data management system 100, is allowed to select at least one of these projects PJ1 and PJ4.

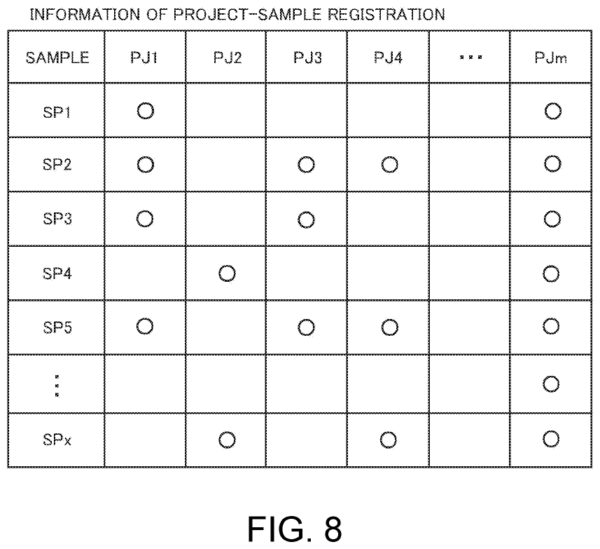

FIG. 8 is a table that illustrates information of project-sample registration. As illustrated in FIG. 8, the information of project-sample registration contains, for each of projects PJ1 to PJm, information of at least one sample managed in accordance with the project (for example, user identification information). In the example illustrated in FIG. 8, samples SP1 to SP3 and SP5 are currently registered in project PJ1, samples SP4 and SPx (x is a plural number) registered in project PJ2, and all of samples SP1 to SPx registered in project PJm.

As per the illustrations of FIGS. 7 and 8, the users who belong to project PJ1 (users U1 to U3) are authorized to access pieces of analysis result data of samples SP1 to SP3 and SP5, while these users are not allowed to access the analysis result data of any other one of samples SP. Users who belong to project PJm (users U4, U5, Un) are authorized to access all of pieces of analysis result data of samples SP1 to SPx.

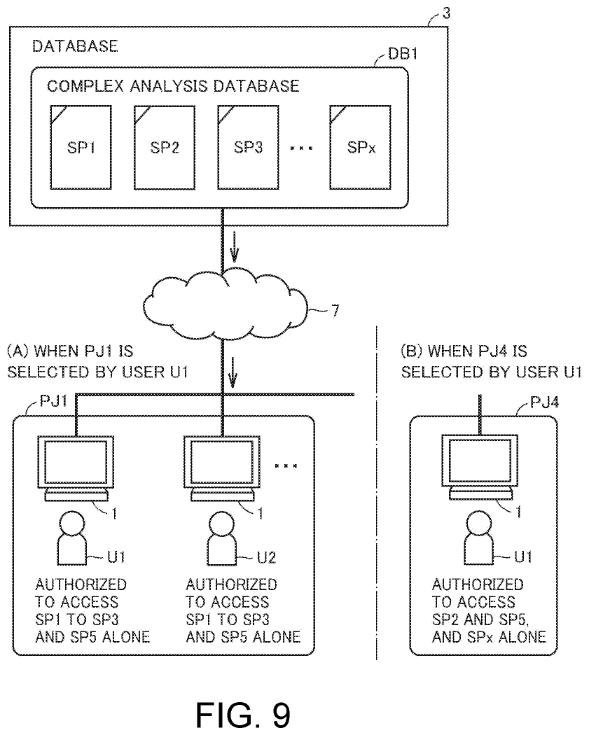

Thus, among pieces of analysis result data of samples SP1 to SPx stored in complex analysis database DB 1 (see FIG. 6), a range of accessible data is decided for each user depending on his/her own project. FIG. 9 is a block diagram that schematically illustrates details of an authority granted to user U1.

As per the information of project-user registration illustrated in FIG. 7, user U1 is currently registered in projects PJ1 and PJ4. In this instance, user U1, at the time of login to complex analysis data management system 100, may be allowed to select at least one of these projects PJ1 and PJ4.

As per the information of project-sample registration illustrated in FIG. 8, samples SP1 to SP3 and SP5 are currently registered in project PJ1, and samples SP2, SP5 and SPx registered in project PJ4.

User U1, when he/she selects project PJ1, may be only allowed to access pieces of analysis result data of samples SP1 to SP3 and SP5 alone which are managed in accordance with project PJ1, as illustrated in FIG. 9(A). User U1, when he/she selects project PJ4, may be only allowed to access pieces of analysis result data of samples SP2, SP5 and SPx alone which are managed in accordance with project PJ4, as illustrated in FIG. 9(B).

Thus, a range of accessible data set for a user registered in two or more projects depends on which of the projects is selected by the user at the time of login to complex analysis data management system 100.

Referring to FIG. 5 again, template database DB4 is used for management of a plurality of templates prepared beforehand for display of sample attribute values (feature amount and property value). The attribute values of a sample include a feature amount extracted from analysis data of the sample and a property value of the sample. Some samples may have no property value. Some samples may have property values that differ in type from one another. In the templates are designed types of the feature amounts extractible from the analysis data obtained by each analyzer 4. In the templates may be designated types of property values in addition to the feature amounts. A plurality of types of templates prepared beforehand may facilitate the process of selecting the sample attribute values.

### Operation of Complex Analysis Data Management System

Next, the operation of complex analysis data management system 100 is described below. Hereinafter are described processing steps relating to the user authority management in server 2 and the processing steps for display in information terminal 1.

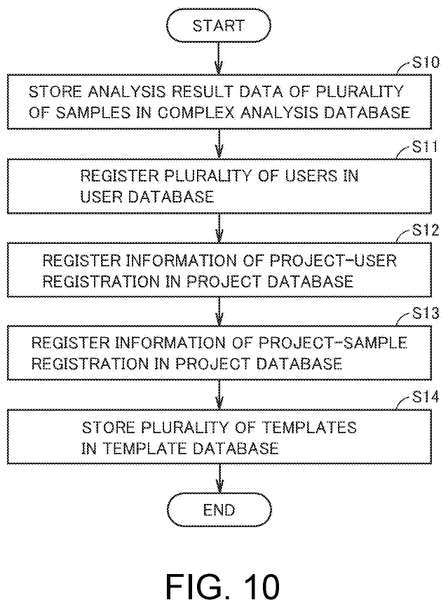

FIG. 10 is a flow chart of processing steps associated with the user authority management in server 2. A program for the steps to be executed as illustrated in the flow chart of FIG. 10 is prestored in ROM 21 of server 2. These processing steps are feasible by the program run by CPU 20. The steps of FIG. 10 are not necessarily executed in the illustrated order and may be optionally executed in different orders. Each step may be repeatedly executed whenever necessary.

Server 2 starts the processing steps illustrated in FIG. 10 in response to the input of the following data through input unit 23; pieces of analysis result data and property values from analyzers 4 and project-related information from manager M1.

In step S10, server 2 first stores pieces of analysis result data of samples SP1 to SPx in complex analysis database DB1 of database 3 (see FIG. 6).

In step S11, server 2 stores, in user database DB2 of database 3, users U1 to Un allowed to log in complex analysis data management system 100.

In steps S12 and S13, server 2 stores, in project database DB3 of database 3, the information of project-user registration (see FIG. 7) and the information of project-sample registration (see FIG. 8) received from manager M1 of complex analysis data management system 100. Step S13 may be executed simultaneously with step S10.

In step S14, server 2 stores a plurality of types of templates in template database DB4.

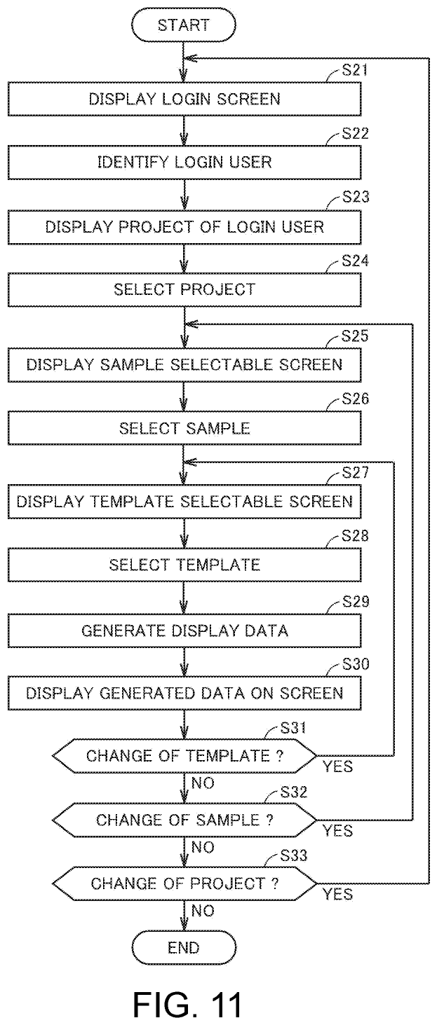

FIG. 11 is a flow chart of processing steps for display in information terminal 1. A program for the steps to be executed as illustrated in the flow chart of FIG. 11 is prestored in ROM 11 of information terminal 1. These processing steps are feasible by the program run by CPU 10.

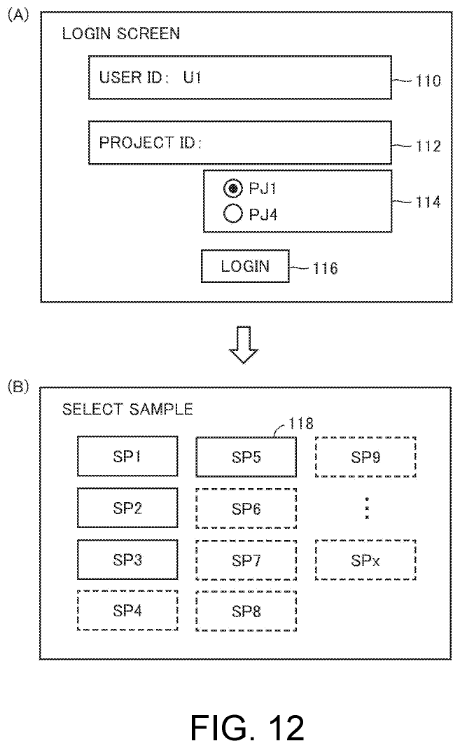

Information terminal 1 starts the processing steps for display illustrated in FIG. 11 in response to the input of a user's login operation through by input unit 13. In step S21, information terminal 1 first displays, on display unit 14, an operation screen (may be referred to as “login screen”) to allow the user to log in complex analysis data management system 100. FIG. 12 is a drawing that illustrates an exemplified operation screen. The operation screen may be prepared based on data stored in database 3.

FIG. 12(A) is a drawing that illustrates an exemplified login screen. On the login screen are displayed icons 110, 112, 114 and 116. Icon 110 is used to input a user's identification information. The user may click icon 110 using input unit 13 and then input his/her user ID.

Icons 112 and 114 are used for project selection. Icon 112 is used to input identification information of a selected project (for example, project ID).

When a user inputs his/her own user ID to icon 110, icon 114 presenting a list of this user's projects is displayed below icon 112. When user U1 logs in complex analysis data management system 100, IDs of projects PJ1 and PJ4 are displayed on icon 114 on the login screen, as illustrated in FIG. 12(A). User U1 may select either one of projects PJ1 and PJ4 using input unit 13. When project PJ1 is selected by user U1, icon 112 automatically receives the input of an ID of project PJ1.

Subsequent to the input of the user and project IDs, icon 116 is clicked with input unit 13 to log in the system, which allows user U1 to log in complex analysis data management system 100.

When user U1 successfully logs in complex analysis data management system 100, information terminal 1 displays an operation screen on which a target to be displayed is selectable (hereinafter, may be referred to as “sample selectable screen”), as illustrated in FIG. 12(B). On the sample selectable screen is displayed a list of samples that have been analyzed by one of analyzers 4 (see FIG. 1). FIG. 12(B) shows a list of samples SP1 to SPx.

Samples SP1 to SPx are each displayed in the form of an icon 118. Of icons 118 forb samples SP1 to SPx, icons 118 of samples registered in a project selected on the login screen (see FIG. 12(A)) alone are accessible and selectable by a user. When project PJ1 is selected by user U1 on the login screen, of plurality of icons 118, four icons 118 alone, which correspond to samples SP1 to SP3 and SP5 registered in project PJ1, are accessible and then selected by user U1, whereas any other icons 118 are inactive not to be selected by user U1.

In FIG. 12(B), all of samples SP1 to SPx are displayed on the operation screen. Instead, icons 118 which correspond to SP1 to SP3 and SP5 registered in project PJ1 may be selectively displayed on the sample selectable screen. The other icons for any samples but samples SP1 to SP3 and SP5 may be selectively not displayed on the sample selectable screen. The samples registered in any project but project PJ1 may be thus not shown and hidden from user U1, so that such samples per se may not even be noticed.

In the example of FIG. 12(B), user U1 is allowed to select a sample to be displayed by clicking icon 118 showing at least one of four samples SP1 to SP3 and SP5.

In the example of FIG. 12(A), a user selects a project when he/she logs in complex analysis data management system 100. Instead, a user may select a project after the login to the system. The timing of project selection is not particularly limited insofar as the project selection has already been done when an application starts to be run to allow accesses to the sample analysis result data.

While the icons are used to display samples SP1 to SPx in the example of FIG. 12(B), the samples may be displayed otherwise. In a data management application, for example, a plurality of data files included in the analysis result data may be displayed in a tree view beneath the samples.

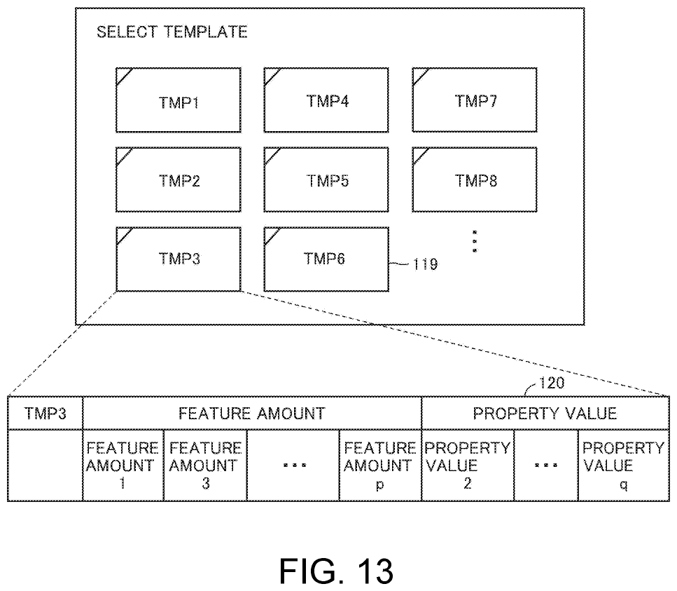

When a user clicks at least one of icons 118 displayed on the sample selectable screen, an operation screen for template selection of FIG. 13 (may be referred to as “template selectable screen”) is displayed on display unit 14. Referring to FIG. 13, the template selectable screen displays a list of templates prepared beforehand. In the example illustrated in FIG. 13, templates TMP1, TMP2, . . . are each displayed in the form of an icon 119.

In the templates are designed types of the feature amounts extractible from the analysis data obtained by each analyzer 4. When, for example, icon 119 showing template TMP3 is clicked with input unit 13, an image 120 showing details of template TMP3 is displayed on the template selectable screen. In image 120 of template TMP3 are designated types of a plurality of feature amounts (first feature amount, third feature amount, . . . (p)^{th} feature amount (p is a plural number).

In the templates are designed types of the property values in addition to the feature amounts. In template TMP3 are designed types of a plurality of property values (second property value, . . . , (q)^{th} property value (q is a plural number).

The selection of sample attribute values (feature amount and property value) to be displayed by a user may be facilitated by thus preparing a plurality of templates designating types of the attribute values. In the example illustrated in FIG. 13, attribute values to be displayed among all of the attribute values included in the analysis result data are selectable when a user clicks icon 119 showing one of the templates.

Referring to FIG. 11 again, in step S22, information terminal 1, when the login screen of FIG. 12(A) receives input of a user ID, identifies the login user with reference to user database DB2. Next, information terminal 1 displays icon 114 showing a list of the login user's projects on the login screen based on the information of project-user registration stored in project database DB3. In step S24, information terminal 1 selects a project in response to the input of an operation for project selection to icon 114.

In step S25, information terminal 1 displays the sample selectable screen of FIG. 12(B). Next, information terminal 1 displays icons 118 showing samples registered in the selected project in a manner that input of a user's selection is receivable based on the information of project-sample registration stored in project database DB3. In step S26, information terminal 1 selects a sample when input of the user's selection is received on the sample selectable screen.

In step S27, information terminal 1 displays the template selectable screen of FIG. 13. Information terminal 1 displays a plurality of icons 119 for templates of different types in a manner that one of them is selectable by a user In step S28, information terminal 1 selects a template (i.e., sample attribute values) in response to the input of selection by the user on the template selectable screen.

In step S29, information terminal 1 generates data to be displayed. Specifically, information terminal 1 accesses server 2 through Internet 7 to obtain the analysis result data of the sample selected in step S26 from complex analysis database DB1 of database 3.

Next, information terminal 1 extracts, from the obtained analysis result data, the sample analysis data and attribute values (feature amount and property value) designated in the template selected in step S28 for each sample. In step S29, information terminal 1 generates the data to be displayed based on these pieces of extracted data.

In step S30, information terminal 1 displays the generated data on the screen of display unit 14. The display screen presents the analysis result data of the sample to be displayed. Thus, a user is allowed to visually check pieces of analysis data and attribute values that are associated with one sample.

When two or more samples are selected in step S26, pieces of analysis result data of the samples displayed next each other on the screen. Thus, a user may be allowed to compare and discuss the displayed pieces of analysis data and attribute values between the different samples.

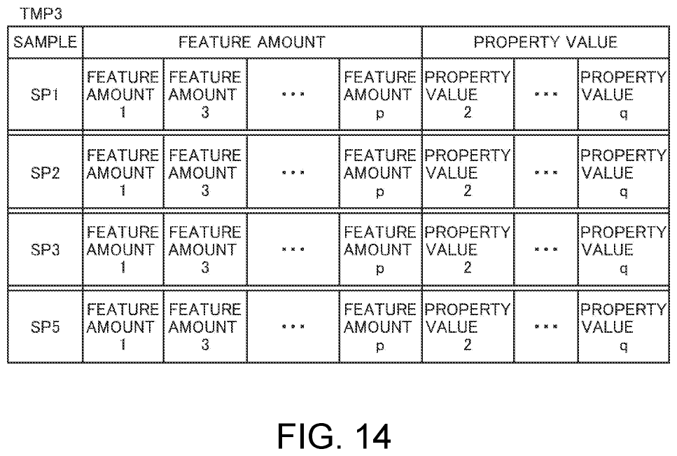

Information terminal 1 may collectively display the attribute values of different samples in the form of a table. FIG. 14 is an exemplified table schematically showing the attribute values of different samples. The table of FIG. 14 may be drawn up using the template selected in step S28 of FIG. 11. In FIG. 14, the attribute values (feature amount and property value) of samples SP1 to SP3 and SP5 registered in project PJ1 are tabulated on template TMP3.

As illustrated in FIG. 14, the attribute values of samples are arranged in a matrix-like form in a table. In this table, the samples are arranged in rows and the attribute values (feature amount and property value) are arranged in columns. Thus, the feature amounts and property values of different samples are arranged next to one another in the direction of columns. A user, with reference to the columns showing the feature amounts and property values of one sample, may readily compare the feature amounts and/or property values between different samples.

Any field in the table of FIG. 14 is left blank, if the feature amount and property value of a sample for the relevant field is not included in the analysis result data of this sample.

In complex analysis data management system 100 according to this embodiment described thus far, a respective one of projects is registered in project database DB3 in association with a user, and a respective one of projects is also registered in this database in association with a sample for which accessibility to the analysis result data is controllable. This may grant each user an authority to access the analysis result data of a sample registered in any project for which the user is registered. Further advantageously, any third parties not registered in a project may be prevented from accessing the analysis result data of a sample registered in this project. Thus, this embodiment may readily achieve data management that enables shared use of the analysis result data while ensuring, at the same time, confidentiality required of this data.

Complex analysis data management system 100 according to this embodiment is directed to determining the user authorities using the frame called “project”. This system may thus achieve successful control of users' accessibility to the analysis result data by registering the users and samples in the relevant projects. As a result, management of the analysis result data may be facilitated, as compared with accessibility to the data being set for each user.

### Other Possible Configurations

### (1) Restriction of Use of Template

In the embodiment described earlier, a user may be allowed to readily access and know the attribute values of any desired sample to be displayed by selecting, from a plurality of types of templates prepared beforehand, a template designating types of the attribute values (feature amount and property value) of the sample.

The feature amounts originated from one sample may include, other than a feature amount(s) uniquely extracted from the analysis data (for example, peak intensity, peak area in a chromatogram), a feature amount(s) obtained through analysis of the extracted feature amount. These feature amounts may include data obtained through a particular analysis conducted in a unique perspective to achieve a project's goals (for example, product's performance or quality to be accomplished). When known by third parties, such feature amounts may possibly lead to leakage of the project's goals, strategies for development and knowhow and should desirably be concealed from any third parties. For the same purpose, some of the sample property values should also be concealed from any third parties.

To ensure confidentiality of the feature amounts and property values, restriction of use may be set for some of the templates. Specifically, a user authority is set for each template subject to restriction of use.

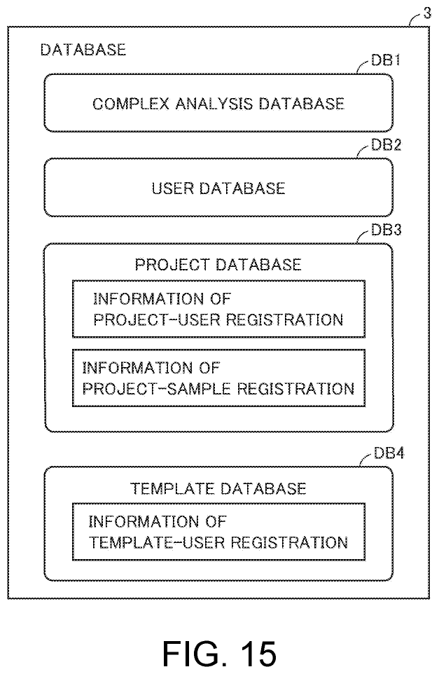

FIG. 15 is a drawing that schematically illustrates functional elements of database 3 according to a modified embodiment. The difference of database 3 illustrated in FIG. 15 to database 3 illustrated in FIG. 5 is the configuration of a template database DB4. Template database DB4 according to this modified embodiment contains “information of template-user registration”.

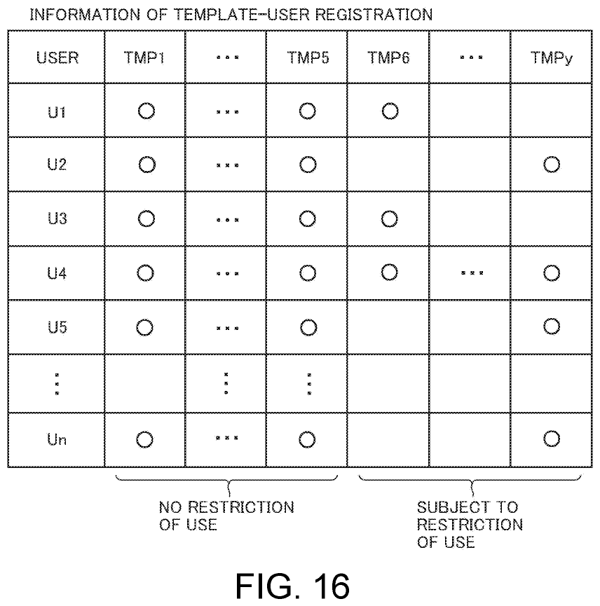

The information of template-user registration is used for management of templates and users in association with each other. FIG. 16 is a table that illustrates the information of template-user registration. In the example illustrated in FIG. 16, of templates TMP1 to TMPy (y is a plural number), templates TMP1 to TMP5 are templates for versatile use that are free of restriction of use. Typically, these restriction-free templates are templates designating types of the feature amounts uniquely extracted from the analysis data.

Of templates TMP1 to TMPy, templates TMP6 to TMPy are subject to restriction of use. The templates subject to restriction of use are templates designating types of the feature amounts obtained by analyzing the feature mounts using uniquely acquired knowledge and knowhow other than the feature amounts uniquely extracted from the analysis data.

All of users U1 to Un are registered in templates TMP1 to TMP5. Users U1 to Un are each allowed to use templates TMP1 to TMP5 without any restriction. In TMP6 to TMPy are registered users granted the use of a respective one of the templates. For example, users U1, U3 and U4 are currently registered in template TMP6. Thus, users U1, U3 and U4 alone are allowed to use template TMP6.

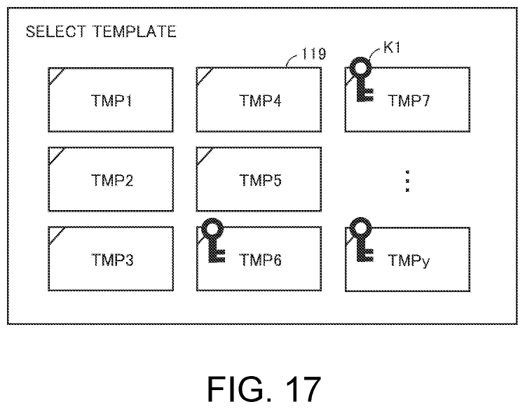

FIG. 17 is a drawing of the template selectable screen. Referring to FIG. 17, the template selectable screen displays a list of templates prepared beforehand. In the example illustrated in FIG. 17, templates TMP1 to TMPy are each displayed in the form of an icon 119.

Among templates TMP1 to TMP6, “key” marks K1 are appended to icons 119 for templates TMP6 to TMPy subject to restriction of use. In this instance, the users registered in the information of template-user registration (see FIG. 16) alone are allowed to select the templates with the key mark K1. Any users unregistered in the information of template-user registration are not authorized to access the content of any one of these templates.

Thus, restriction of use set for any templates designating types of the attribute values to be concealed may enable shared use of these templates among users U1 to Un, while ensuring, at the same time, confidentiality required of the attribute values. By sharing, among users U1 to Un, any templates designating types of the attribute values for versatile use, complex analysis data management system 100 may greatly improve in usability. By granting the use of any templates designating types of the attribute values to be concealed to a limited number of users, expertise and knowhow possessed by such users may be prevented from leaking to the other users.

### Aspects

It should naturally be understood that the embodiments described thus far are specific examples of the following aspects of this disclosure.

(First Aspect) A complex analysis data management system according to an aspect of this disclosure is for management of analysis result data obtained by a plurality of types of analyzers for each of a plurality of samples. The complex analysis data management system includes: a complex analysis database; a user database; a project database; a project-sample registering unit; a project-user registering unit; a login management unit; and a display control unit. The complex analysis database manages the analysis result data in association with each of the plurality of samples. The user database manages a plurality of users who can log in the complex analysis data management system. The project database manages a plurality of projects. The project-sample registering unit registers, in the project database, a respective one of the plurality of projects in association with at least one selected from the plurality of samples. The project-user registering unit registers, in the project database, a respective one of the plurality of projects in association with at least one selected from the plurality of users. The login management unit identifies a login user in response to the input of a login operation by one of the plurality of users. The display control unit displays a project associated with the login user in a selectable manner on an information terminal operated by the login user. The display control unit extracts, from the complex analysis database, the analysis result data of a sample associated with the project selected by the login user and displays the extracted analysis result data on the information terminal.

The complex analysis data management system according to the first aspect takes the following steps for accessibility to the analysis result data of different samples managed by the complex analysis database, registering a respective one of projects in association with a user, and registering a respective one of projects in association with a sample for which accessibility to the analysis result data is controllable. Thus, the analysis result data of samples registered in the projects may be protected from being revealed to any third parties who are unregistered in the relevant projects. This system may thus achieve data management that enables shared use of the analysis result data, while ensuring, at the same time, confidentiality required of this data.

(Second Aspect) The complex analysis data management system according to the first aspect further includes a template database and a template-user registering unit. The template database manages templates for which types of data to be displayed on the information terminal are designated. The template-user registering unit registers, in the template database, a respective one of the templates in association with at least one selected from the plurality of users. The display control unit displays a template associated with the login user in a selectable manner on the information terminal. The display control unit displays, on the information terminal, the analysis result data of the sample associated with the project selected by the login user using a template selected by the login user.

As for the templates used to display the analysis result data, the complex analysis data management system according to the second aspect registers a respective one of the templates in association with a user. This may prevent leakage of the content of each template to any unregistered third parties. This may enable shared use of the templates while ensuring, at the same time, confidentiality required of the templates.

(Third Aspect) In the complex analysis data management system according to the second aspect, the template database manages a template subject to restriction of use and a template free of restriction of use. The template-user registering unit registers, in the template database, the template subject to restriction of use in association with at least one selected from the plurality of users. The template-user registering unit registers, in the template database, the template free of restriction of use in association with the plurality of users.

In the complex analysis data management system according to the third aspect, any templates designating types of data to be concealed are subject to restriction of use. This may enable shared use of these templates among users, while ensuring, at the same time, confidentiality required of the templates. By sharing, among the users, any templates designating types of the attribute values for versatile use, the complex analysis data management system may greatly improve in usability. By granting the use of any templates designating types of data to be concealed to a limited number of users, expertise and knowhow possessed by such users may be prevented from leaking to the other users.

(Fourth Aspect) In the complex analysis data management system according to the first to third aspects, the analysis result data includes pieces of analysis data obtained by analyzers of different types, respectively, and at least one feature amount obtained through analysis of these pieces of analysis data.

In the complex analysis data management system according to the fourth aspect, each of the users, for any sample defined according to an authority granted to a project to which he/she belongs, may be able to readily perform multilateral analysis of the analysis results and feature amounts obtained by different analyzers.

(Fifth Aspect) In the complex analysis data management system according to the fourth aspect, the analysis result data further includes a sample property value(s) obtained from any information but the pieces of analysis data.

In the complex analysis data management system according to the fifth aspect, each of the users, for any sample defined according to an authority granted to a project to which he/she belongs, may be able to readily perform multilateral analysis of the analysis results, feature amounts and property values obtained by different analyzers.

(Sixth Aspect) A complex analysis data management method according to an aspect of this disclosure is for management of analysis result data obtained by a plurality of types of analyzers for each of a plurality of samples. The complex analysis data management method includes: managing analysis result data in association with each of the plurality of samples using a complex analysis database; managing a plurality of users allowed to log in a complex analysis data management system using a user database; managing a plurality of projects using a project database; registering, in the project database, a respective one of the plurality of projects in association with at least one selected from the plurality of samples; registering, in the project database, a respective one of the plurality of projects in association with at least one selected from the plurality of users; identifying a login user in response to input of a login operation by one of the plurality of users; displaying a project associated with the login user in a selectable manner on an information terminal operated by the login user; and extracting the analysis result data of a sample associated with the project selected by the login user from the complex analysis database and displaying the extracted analysis result data on the information terminal.

The complex analysis data management method according to the sixth aspect takes the following steps for accessibility to the analysis result data of different samples managed by the complex analysis database; registering a respective one of projects in association with a user, and registering a respective one of projects in association with a sample for which accessibility to the analysis result data is controllable. This may enable shared use of the analysis result data, while ensuring, at the same time, confidentiality required of the analysis result data.

(Seventh Aspect) A complex analysis data management program according to an aspect of this disclosure is for management of analysis result data obtained by a plurality of types of analyzers for each of a plurality of samples. The complex analysis data management program prompts a computer execute the following: managing analysis result data in association with each of a plurality of samples using a complex analysis database; managing a plurality of users allowed to log in a complex analysis data management system using a user database; managing a plurality of projects using a project database; registering, in the project database, a respective one of the plurality of projects in association with at least one selected from the plurality of samples; registering, in the project database, a respective one of the plurality of projects in association with at least one selected from the plurality of users; identifying a login user in response to input of a login operation by one of the plurality of users; displaying a project associated with the login user in a selectable manner on an information terminal operated by the login user; and extracting the analysis result data of a sample associated with the project selected by the login user from the complex analysis database and displaying the extracted analysis result data on the information terminal.

As for accessibility to the analysis result data of different samples managed by the complex analysis database, the complex analysis data management program according to the seventh aspect thus prompts the computer to; register a respective one of projects in association with a user, and register a respective one of projects in association with a sample for which accessibility to the analysis result data is controllable. This may enable shared use of the analysis result data, while ensuring, at the same time, confidentiality required of the analysis result data.

The embodiments and the modified embodiment disclosed herein are intended cover all of the combinations described in the embodiments, including any possible combinations not mentioned in this specification, without leading to any inconvenience or contradiction to the benefits of this disclosure.

All of the embodiments are disclosed herein by way of illustration and example only and should not be construed as limiting by any means the scope of this disclosure. The scope of this disclosure is solely defined by the appended claims and is intended to cover the claims, equivalents, and all of possible modifications made without departing the scope of this disclosure.

### REFERENCE SIGNS LIST

1: information terminal, 2: server, 3: database, 4: analyzer, 5: device body, 6: information processor, 7: Internet, 10, 20, 60: CPU, 11, 21, 61: ROM, 12, 22, 62: RAM, 13, 23, 63: input unit, 14, 64: display unit, 15, 25, 65: HDD, 16, 26, 66: communication I/F, 17: selecting unit, 18: display data generating unit, 19: display control unit, 24: I/O, 27: analysis result data obtaining unit, 28: property value obtaining unit, 29: synthesizing unit, 30: registration information obtaining unit, 31: managing unit, 67: analysis data obtaining unit, 68: feature amount extracting unit, 69: information obtaining unit, 100: complex analysis data management system, 110, 112, 114, 116, 118, 119: icon, 120: image, U1 to Un: user, M1: manager, PJ1 to PJm: project, TMP1 to TMPy: template, DB1: complex analysis database, DB2: user database, DB3: project database, DB4: template database, SP1 to SPx: sample

1. A complex analysis data management system for management of analysis result data obtained by a plurality of types of analyzers for each of a plurality of samples, the complex analysis data management system comprising:
a complex analysis database that manages the analysis result data in association with each of the plurality of samples;
a user database that manages a plurality of users who can log in the complex analysis data management system;
a project database that manages a plurality of projects;
a project-sample registering unit that registers, in the project database, a respective one of the plurality of projects in association with at least one selected from the plurality of samples;
a project-user registering unit that registers, in the project database, a respective one of the plurality of projects in association with at least one selected from the plurality of users;
a login management unit that identifies a login user in response to input of a login operation by one of the plurality of users; and
a display control unit that displays a project associated with the login user in a selectable manner on an information terminal operated by the login user, wherein
the display control unit further extracts, from the complex analysis database, the analysis result data of a sample associated with the project selected by the login user and displays the extracted analysis result data on the information terminal.

2. The complex analysis data management system according to claim 1, further comprising:
a template database that manages templates for which types of data to be displayed on the information terminal are designated; and
a template-user registering unit that registers, in the template database, a respective one of the templates in association with at least one selected from the plurality of users, wherein
the display control unit displays a template associated with the login user in a selectable manner on the information terminal, and
the display control unit displays, on the information terminal, the analysis result data of the sample associated with the project selected by the login user using a template selected by the login user.

3. The complex analysis data management system according to claim 2, wherein
the template database manages a template subject to restriction of use and a template free of restriction of use,
the template-user registering unit registers, in the template database, the template subject to restriction of use in association with at least one selected from the plurality of users, and
the template-user registering unit registers, in the template database, the template free of restriction of use in association with the plurality of users.

4. The complex analysis data management system according to claim 1, wherein
the analysis result data includes:
a plurality of pieces of analysis data obtained by the plurality of types of analyzers, respectively; and
at least one feature amount obtained through analysis of the plurality of pieces of analysis data.

5. The complex analysis data management system according to claim 4, wherein
the analysis result data further includes a sample property value obtained through any information but the plurality of pieces of analysis data.

6. A complex analysis data management method for management of analysis result data obtained by a plurality of types of analyzers for each of a plurality of samples, the complex analysis data management method comprising:
managing the analysis result data in association with each of the plurality of samples using a complex analysis database;
managing a plurality of users using a user database;
managing a plurality of projects using a project database;
registering, in the project database, a respective one of the plurality of projects in association with at least one selected from the plurality of samples;
registering, in the project database, a respective one of the plurality of projects in association with at least one selected from the plurality of users;
identifying a login user in response to input of a login operation by one of the plurality of users;
displaying a project associated with the login user on an information terminal operated by the login user in a selectable manner; and
extracting the analysis result data of a sample associated with the project selected by the login user from the complex analysis database and displaying the extracted analysis result data on the information terminal.

7. A non-transitory computer readable storage medium storing a complex analysis data management program for management of analysis result data obtained by a plurality of types of analyzers for each of a plurality of samples, the complex analysis data management program causing the computer to execute the following:
managing the analysis result data in association with each of the plurality of samples using a complex analysis database;
managing a plurality of users using a user database;
managing a plurality of projects using a project database;
registering, in the project database, a respective one of the plurality of projects in association with at least one selected from the plurality of samples;
registering, in the project database, a respective one of the plurality of projects in association with at least one selected from the plurality of users;
identifying a login user in response to input of a login operation by one of the plurality of users;
displaying a project associated with the login user on an information terminal operated by the login user in a selectable manner; and
extracting the analysis result data of a sample associated with the project selected by the login user from the complex analysis database and displaying the extracted analysis result data on the information terminal.
